(19) United States
(12) Patent Application Publication
(10) Pub. No.: US 2026/0056993 A1
(43) Pub. Date: Feb. 26, 2026

(54) GENERATING AND QUERYING BIOLOGICAL DATA GRAPHS USING MACHINE LEARNING MODELS

(71) Applicant: NEUMORA THERAPEUTICS, INC., Watertown, MA (US)

(72) Inventor: Tathagata Banerjee, Waltham, MA (US)

(21) Appl. No.: 19/296,646

(22) Filed: Aug. 11, 2025

Related U.S. Application Data
(60) Provisional application No. 63/685,910, filed on Aug. 22, 2024.

(51) Int. Cl. G06F 16/334; G06F 16/901

(52) U.S. Cl. CPC G06F 16/334; G06F 16/9024

(57) ABSTRACT

Methods, systems, and apparatus, including computer programs encoded on a computer storage medium, for receiving a query, processing a textual representation of the query using a language processing neural network to generate an embedding of the query, generating a response to the query using: (i) the embedding of the query, and (ii) graph data representing a biological data graph comprising a set of nodes and a set of edges, wherein each node represents a respective biological entity, each edge connects a respective pair of nodes in the biological data graph and represents a relationship between a pair of biological entities, and each edge in the biological data graph is associated with a respective edge embedding representing a set of textual data describing the relationship represented by the edge, and the edge embeddings are generated using the language processing neural network, and outputting the response to the query.

### CROSS-REFERENCE TO RELATED APPLICATIONS

This application claims the benefit of priority to U.S. Provisional Application No. 63/685,910, filed on Aug. 22, 2024, the contents of which are herein incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can generate, update, and query a biological data graph that characterizes biological entities and the relationships between them. More specifically, this specification describes a biological data query system that can query a biological data graph and a biological data graph generation and update system that can generate and update a biological data graph. In this specification, updating a biological data graph can refer to processing and adding new biological information to the graph.

Throughout this specification, a “biological entity” can refer to, e.g., a cellular structure, or a gene, or a protein, or a protein complex, or a signaling pathway, or a tissue, or an organ, or an enzyme, or a hormone, or an antibody, or an organelle, or a receptor, or a metabolite, or any other compound, substance, or structure included in or related to a biological system or subject.

A “subject” can refer to, e.g., a collection of one or more cells, or a tissue, or an organism, e.g., an animal or a human.

An “embedding” of an entity (e.g., of a node or an edge in a graph) can refer to an ordered collection of numerical values, e.g., a vector, matrix, or other tensor of numerical values, representing the entity.

A “graph” can include: (i) a set of nodes, and (ii) a set of edges, where each edge can connect a respective pair of nodes. As an example, each node can represent a respective biological entity and each edge can represent an association or relationship between a respective pair of nodes. For instance, an edge can encode a relationship such as: “is associated with”, or “is caused by”, or “is experimentally observed”, and so forth.

Biological data graphs integrate data into a common framework that maintains the relationship between nodes in an ontology, which is a representation of the node entities and how they are linked together in the graph. For example, the biological data graph can be described in terms of a topology that represents the relational structure and geometric organization of the graph.

The nodes can be heterogeneous. As an example, the biological entity nodes can include genotype nodes, phenotype, and drug nodes. The edges can additionally store (be associated with) textual data as metadata with respect to the relationships between nodes. For example, the relationships between biological entity nodes represented by edges can be associated with textual content describing the relationship. More specifically, a scientific paper or a paragraph detailing a biological pathway between two node entities, one of which is a gene and the other of which is a certain disease, can be associated with an edge. As another example, each edge can also be associated with data defining a document, e.g., the origin document describing the relationship represented by the edge, from a corpus of documents sourced to generate or update the biological data graph.

The system can generate, update, and query the biological data graph using one or more language processing neural networks. In this specification, a language processing neural network is a deep neural network that can process a textual input to generate a predicted output that characterizes the textual input. For instance, the predicted output can be a “next-character” prediction, e.g., that defines a score distribution over a set of elements include one or more of: characters, n-grams, word pieces, or words, where the score for an element characterizes a likelihood that the element is a next element that extends the textual input. The language processing neural network can have any appropriate neural network architecture. For instance, the language processing neural network can be configured to perform parallel processing of a sequence of words in the textual input using a multi-headed attention mechanism to capture associations between each word. As another example, the language processing neural network can have a recurrent neural network architecture that is configured to sequentially process each word in the input text sequence and to maintain a hidden state to capture information about the previous words processed. In particular, a language processing neural network can process and understand a textual input and produce coherent outputs based on knowledge gained from large textual training datasets.

More specifically, one or more language processing neural networks can be paired with a graph neural network to process initial textual biological data to generate the biological data graph and to process new textual biological data to update the biological data graph as additional information, e.g., a new node and edge or edge between existing nodes, is added to the graph. Additionally, a language processing neural network, e.g., a question-answering model, can be used to query the biological data graph by processing the query and textual data from the biological data graph to output a query response.

In particular, processing the textual data from the biological data graph to output a query response can involve embedding the nodes and edges of the graph. More specifically, the nodes and edges of the graph can be embedded with a language processing neural network, e.g., by taking an intermediate output from the language processing neural network, such that the relational structure of the ontology is maintained in the embeddings. In a particular example, embedding the edges of the biological data graph can involve embedding the textual content associated with the edges, which can then be used to query the graph. In another example, the node embeddings of the biological data graph can be used to query the graph by defining a measure of similarity between the node embeddings.

According to a first aspect, there is provided a method for receiving a query, processing a textual representation of the query using a language processing neural network to generate an embedding of the query, generating a response to the query using: (i) the embedding of the query, and (ii) graph data representing a biological data graph comprising a set of nodes and a set of edges, wherein: each node in the biological data graph represents a respective biological entity, each edge in the biological data graph connects a respective pair of nodes in the biological data graph and represents a relationship between a pair of biological entities corresponding to the respective pair of nodes, and each edge in the biological data graph is associated with a respective edge embedding representing a set of textual data describing the relationship represented by the edge, and the edge embeddings associated with the edges in the biological data graph are generated using the language processing neural network, and outputting the response to the query.

In some implementations, the edge embeddings associated with the edges in the biological data graph are generated using the language processing neural network by performing operations comprising generating: (i) a respective initial edge embedding for each edge in the biological data graph using the language processing neural network, and (ii) an initial node embedding for each node in the biological data graph, and processing a network input that comprises: (i) the graph data representing the biological data graph, and (ii) the initial edge embeddings of the edges in the biological data graph and the initial node embeddings of the nodes in the biological data graph, using a graph neural network, to generate the edge embeddings associated with the edges in the biological data graph.

In some implementations, for each edge in the biological data graph, the initial edge embedding associated with the edge comprises an intermediate output generated by the language processing neural network in response to processing the set of textual data describing the relationship represented by the edge.

In some implementations, for one or more nodes in the biological data graph, generating the initial node embedding for the node comprises one or more of generating the initial node embedding for the node by processing textual data characterizing the biological entity represented by the node using the language processing neural network, or setting the initial node embedding for the node to a default embedding, or setting the initial node embedding for the node to a randomly sampled embedding.

In some implementations, the graph neural network comprises a plurality of graph neural network layers that are each configured to receive current edge embeddings associated with the edges in the biological data graph and current node embeddings associated with the nodes in the biological data graph, and update the current edge embeddings and the current node embeddings by performing message passing operations that are conditioned on a topology of the biological data graph and are parametrized by a set of graph network layer parameters.

In some implementations, the language processing neural network and the graph neural network have been jointly trained by performing operations comprising, at each of a plurality of training iterations, generating a respective current edge embedding for each edge in the biological data graph and a respective current node embedding for each node in the biological data graph using the language processing neural network and the graph neural network, and adjusting the current values of the set of parameters of the language processing neural network and the set of parameters of the graph neural network based on an objective function that depends on at least the current node embeddings.

In some implementations, the objective function encourages an increase in similarity between node embeddings of nodes that are connected by an edge in the biological data graph.

In some implementations, the objective function encourages a decrease in similarity between node embeddings of nodes that are not connected by an edge in the biological data graph.

In some implementations, adjusting the current values of the set of parameters of the language processing neural network and the set of parameters of the graph neural network based on an objective function that depends on the current edge embeddings comprises determining gradients of the objective function with respect to the set of parameters of the language processing neural network and the set of parameters of the graph neural network, and adjusting the current values of the set of parameters of the language processing neural network and the set of parameters of the graph neural network using the gradients.

In some implementations, the language processing neural network has been pretrained to perform a language modeling task.

In some implementations, generating the response to the query using: (i) the embedding of the query, and (ii) the biological data graph, comprises selecting one or more edges in the biological data graph based on a comparison between the embedding of the query and the edge embeddings of the edges in the biological data graph, and generating the response to the query based on the textual data describing the relationships represented by the selected edges in the biological data graph.

In some implementations, selecting one or more edges in the biological data graph based on the comparison between the embedding of the query and the edge embeddings of the edges in the biological data graph comprises determining a respective similarity measure between: (i) the embedding of the query, and (ii) edge embeddings for each of one or more edges in the biological data graph, and selecting one or more edges in the biological data graph based on the similarity measures.

In some implementations, selecting one or more edges in the biological data graph based on the similarity measures comprises selecting one or more edges associated with edge embeddings having highest similarity to the embedding of the query from the edges in the biological data graph.

In some implementations, generating the response to the query based on the textual data describing the relationships represented by the selected edges in the biological data graph comprise processing a textual prompt that includes: (i) the query, and (ii) the textual data describing the relationships represented by the selected edges in the biological data graph, using a question-answering machine learning model to generate the response to the query.

In some implementations, the question-answering machine learning model comprises an autoregressive neural network trained to perform next-character prediction.

In some implementations, the query identifies a first biological entity and a second biological entity, and wherein generating the response to the query comprises determining a similarity measure between: (i) a node embedding of a node in the biological data graph that represents the first biological entity, and (ii) a node embedding of a node in the biological data graph that represents the second biological entity, and generating the response to the query based at least in part on the determined similarity measure.

In some implementations, the embedding of the query comprises an intermediate output generated by the language processing neural network in response to processing the textual representation of the query.

In some implementations, the biological data graph comprises at least 100,000 nodes.

In some implementations, generating the response to the query requires less than 1 minute.

In some implementations, the query concerns a relationship between a first biological entity and a second biological entity.

In some implementations, the first biological entity comprises a gene and the second biological entity comprises a drug.

In some implementations, receiving the query comprises receiving the query from a user.

In some implementations, outputting the response to the query comprises one or more of: providing the response to a user; storing the response in a memory; or transmitting the response over a data communications network.

According to a second aspect, there is provided a method for obtaining graph data defining a biological data graph comprising a set of nodes and a set of edges, wherein: each node in the biological data graph represents a respective biological entity, each edge in the biological data graph connects a respective pair of nodes in the biology data graph and represents a relationship between a pair of biological entities corresponding to the respective pair of nodes, and iteratively updating the graph data representing the biological data graph using a language processing machine learning model, comprising, at each of a plurality of iterations: obtaining a current corpus of documents comprising textual data, processing textual data from the current corpus of documents using the language processing neural network to generate data defining a plurality of biological relationships described by the textual data, and updating the biological data graph based on the plurality of biological relationships.

In some implementations, for each of the plurality of biological relationships, the data defining the biological relationship defines at least: (i) a pair of biological entities comprising a first biological entity and a second biological entity, and (ii) a relationship between the pair of biological entities.

In some implementations, updating the biological data graph based on the plurality of biological relationships comprises, for one or more of the biological relationships, adding a new edge to the biological data graph to represent the biological relationship.

In some implementations, updating the biological data graph based on the plurality of biological relationships further comprises, for one or more of the biological relationships, adding one or more new nodes to the biological data graph to represent the biological relationship.

In some implementations, associating the new edge in the biological data graph with data identifying a document, from the current corpus of documents, that comprises textual data processed by the language processing neural network to identify the biological relationship.

In some implementations, the method further comprises receiving a query, and, at each of the plurality of iterations, after updating the biological data graph based on the plurality of biological relationships, generating a current response to the query based on the biological data graph.

In some implementations, the language processing machine learning model comprises a neural network.

In some implementations, the language processing machine learning model has been trained to perform a language modeling task.

In some implementations, the language processing machine learning model been fine-tuned to perform a task of extracting biological relationships from textual data.

In another aspect, there is provided a system comprising one or more computers and one or more storage devices storing instructions that are operable, when executed by the one or more computers, to cause the one or more computers to perform the method of any one of the example implementation methods described.

In another aspect, there is provided a computer storage medium encoded with a computer program, the program comprising instructions that are operable, when executed by data processing apparatus, to cause the data processing apparatus to perform the method of any one of the example implementation methods described.

Particular embodiments of the subject matter described in this specification can be implemented so as to realize one or more of the following advantages.

This specification describes techniques for accumulating biological knowledge in a scalable knowledge management framework using a biological data graph to integrate a wide variety of biological information. In particular, the biological data graph can relate and maintain relationships between biological entities as well as update relationships in the biological data graph by creating new edges and nodes. In contrast, to aggregate similar biological information by hand, users, e.g., scientists, would be tasked with reading papers describing the entities of interest and categorizing a relationship between them in a process that is not easily scalable. In particular, a user can spend a prohibitive amount of time searching for two biological entities of interest across a number of publications in order to characterize the relationship between them.

Additionally, even after finding a source that defines a relationship between two biological entities, the knowledge gained can be siloed away from other users, e.g., if the knowledge of the subject, object, and relationship of interest are not transcribed somewhere accessible to users other than the user that found the information, then the process may need to be repeated. Generating and updating a biological data graph with an organized system can address these issues in a scalable approach by unifying the data in a persistent manner that allows for the addition of new information to the graph in an accessible format.

After the data has been accumulated and integrated in the biological data graph, users can use the biological data graph to tackle problems such as target discovery, drug discovery, drug repurposing, off-target prediction, and biomarker discovery. As an example, in a target discovery problem in which a user is trying to determine which gene or protein to target with a drug, the user can spend more time compiling incomplete information from scientific literature than analyzing the details in order to identify a target. In particular, the biological data graph can be used to accelerate the drug discovery and development process by generating and maintaining a single persistent data source that unifies relevant biological entity information that is often siloed in different sources.

The biological data graph can be used for one or more downstream machine learning tasks, e.g., by querying the biological data graph. For example, a question-answer model can be configured for information retrieval to enable users to query the graph, e.g., ask questions about how one biological entity is related to another biological entity using current edge or node embeddings of the graph.

Additionally, the ability to configure machine learning models to process the biological data graph can provide a useful tool to users who can create their own custom models. For example, a machine learning model can be configured and trained to process the biological data graph to predict which disease is caused by an input gene. As another example, a machine learning model can be configured to monitor additions to the biological data graph to assess the importance of new connections or potential new connections. In particular, paths between biological entity nodes can be monitored to assess relationships between the biological entities represented by the nodes. Paths between nodes can be one-hop, i.e., only one edge away, or multi-hop, i.e., multiple edges away. In particular, new paths can be assessed when a new node or edge is added to the biological data graph. Furthermore, cycles between nodes can be created by traversing the biological data graph in a path that starts and ends at the same node and analyzed to assess potentially previously unknown relationships between biological entities.

The system described in this specification can enable reduced consumption of resources such as computational resources (e.g., memory and computing power), network bandwidth, and so forth. For instance, the system can leverage a language processing neural network and a biological data graph to generate a high-quality, comprehensive response to a query that integrates and synthesizes information from across multiple sources. Without the benefit of the system, a user might be required to perform a large number of individual searches, e.g., using a search engine, thus consuming more network bandwidth. As another example, the system can generate embeddings for the elements (e.g., nodes and edges) of a biological data graph using a language processing neural network, and then enrich the embeddings using a graph neural network that is jointly trained with the language processing neural network. Initializing the embeddings using the language processing neural network can enable the graph neural network to perform fewer message passing operations than would be required, e.g., if the embeddings were initialized using a less effective encoding technique, thus reducing consumption of computational resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example biological data query system.

FIG. 2 is a block diagram of an example biological data graph generation and update system.

FIG. 3 depicts an example biological data graph, including node and edge embeddings.

FIG. 4 depicts an example of updating an existing biological data graph using a language processing neural network to process new textual biological data and using a graph neural network to update the nodes and edge embeddings to reflect the new information.

FIG. 5 illustrates an example of a question-answering model processing a query and the biological data graph to provide a response to an end user.

FIG. 6 illustrates an example process for jointly training a language processing neural network and the graph neural network to update the biological data graph.

FIG. 7 is a flow diagram of an example process for responding to a query using a biological data graph with a language processing neural network.

FIG. 8 is a flow diagram of a first example of generating a query response using the edge embeddings of the biological data graph.

FIG. 9 is a flow diagram of a second example of generating a query response using the node embeddings of the biological data graph.

FIG. 10 is a flow diagram of an example process for jointly training the language processing neural network and the graph neural network to generate the embeddings of the biological data graph.

FIG. 11 is a flow diagram of an example process for updating a biological data graph using a language processing neural network.

Like reference numbers and designations in the various drawings indicate like elements.

### DETAILED DESCRIPTION

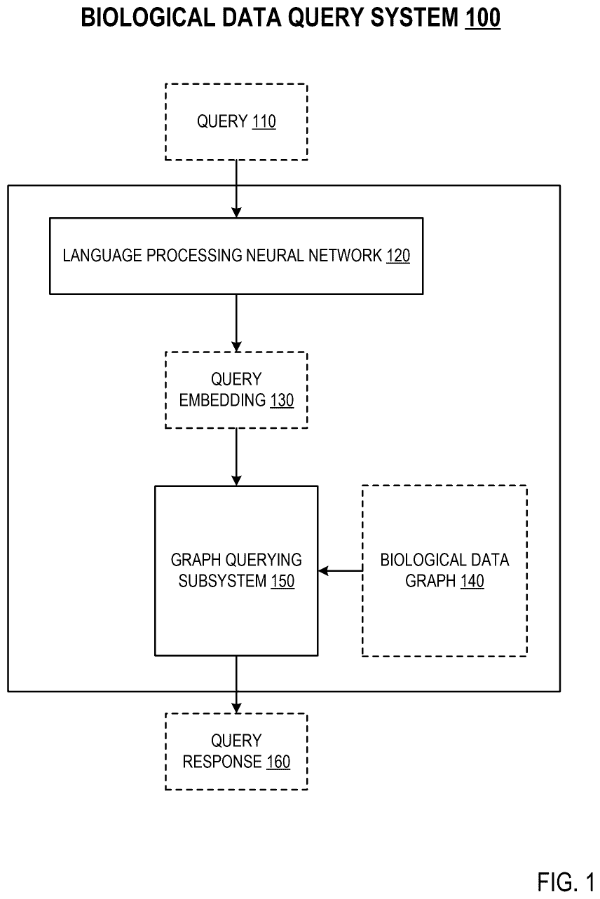

FIG. 1 shows an example biological data query system 100. The biological data query system 100 is an example of a system implemented as computer programs on one or more computers in one or more locations in which the systems, components, and techniques described below are implemented. The system 100 can include a language processing neural network 120, a graph querying subsystem 150, and a biological data graph 140, which are each described in more detail next (and throughout this specification).

The biological data query system 100 is configured to process a query 110, e.g., a textual representation of a query, to generate a response to the query 160. In particular, the system 100 can use a language processing neural network 120 to process the query 110 and generate a query embedding 130. The system 100 can then further process the query embedding 130 along with the biological data graph 140 using a graph querying subsystem 150 to generate a query response 160.

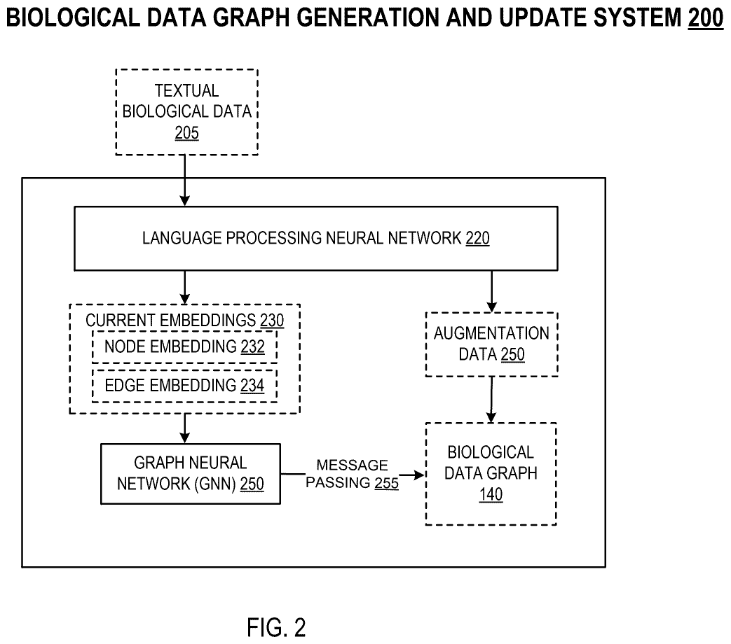

The biological data graph 140 includes a set of nodes representing biological entities and a set of edges representing relationships between the biological entities. The graph 140 can be queried to extract information regarding the biological entities and the relationships between biological entities represented in the ontology of the graph 140. In particular, each edge in the biological data graph 140 can be associated with a respective edge embedding representing a set of textual data that describes the relationship represented by the edge, and each node in the biological data graph 140 can be associated with a respective node embedding representing the aggregated information from the textual data of the edges in the neighborhood, e.g. within one or more nearby hops, of each node. An example for generating and updating the biological data graph 140 and its associated node and edge embeddings will be covered in more detail with respect to FIG. 2.

The system 100 can receive the query 110 from any appropriate source. For instance, the system can receive the query from a user, e.g., through an application programming interface (API) made available by the system 100, or through a graphical or text-based user interface, or from any other appropriate source. In some cases, the user is remotely located from the system 100 and can provides the query to the system over a data communications network, e.g., internet.

As an example, the query 110 can concern a relationship between a first biological entity and a second biological entity in the biological data graph 140, e.g., “What is relationship between gene A and gene B?”. As another example, the query can specify a request to identify a portion of textual content or a document describing the relationship between a first biological entity and a second biological entity. In some cases, the query is specified as text, e.g., a textual representation. In other cases, the query is specified verbally as an audio input, in which case an intermediate processing step can convert the audio input into a textual representation.

The language processing neural network 120 can process the query 110 to generate a query embedding 130. In particular, the embedding of the query can be derived from an intermediate output of the language processing network, e.g., an embedding generated by one or more intermediate (hidden) layers of the language processing neural network 120.

The language processing neural network 120 can have any appropriate neural network architecture that enables the language processing neural network 120 to perform its described functions. In particular, the language processing neural network 120 can include any appropriate types of neural network layers (e.g., fully connected layers, convolutional layers, attention layers, etc.) in any appropriate number (e.g., 5 layers, or 10 layers, or 100 layers) and connected in any appropriate configuration (e.g., as a directed graph of layers). A particular example of a language processing neural network architecture is a transformer architecture, as described in: “Attention Is All You Need.”

The query embedding 130 can then be processed by a graph querying subsystem 150 to identify the textual content relevant to addressing the query 110 within the biological data graph 140, e.g., textual content associated with either node or edge embeddings of the graph 140. As an example, the query embedding 130 can be used to select one or more edges in the biological data graph 140. As another example, the query embedding 130 can be used to select one or more nodes in the biological data graph 140. In particular, the graph querying subsystem 150 can select the relevant edges or nodes with respect to the query 110 by determining a respective similarity measure, e.g., a measure of distance in edge or node embedding space, between the query embedding 130 and the edge or node embeddings, e.g., by selecting the edge or node embeddings with the highest similarity to the query embedding.

In the case of the system 100 using the query embedding 130 to select relevant edges, the graph querying subsystem 150 can then process a textual prompt that includes the query 110 and the textual data describing the relationships represented by the selected edges in the biological data graph 140, e.g., using a question-answering machine learning model, to generate the query response 160. In some examples, the question-answering machine learning model can include an autoregressive neural network trained to perform next-character prediction. In the case of the system 100 using the query embedding to select relevant nodes, the graph querying subsystem 150 can directly compare the node embeddings, e.g., using a measure of distance in node embedding space, to generate the query response 160.

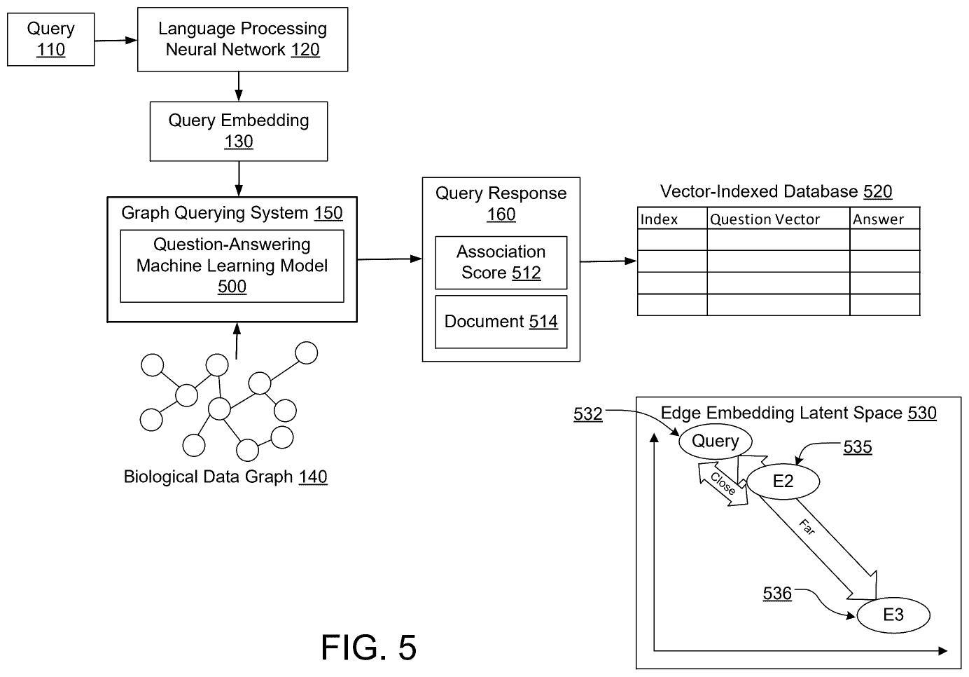

In particular, the query response 160 can include a textual response that includes a document, e.g. from the corpus of documents used to generate or update the graph 140, that supports the response 160 and was stored with the node or edge embedding during training. A particular method for querying the graph and generating a query response 160 will be covered in more detail in FIG. 5.

The system 100 can provide the query response 160, e.g., to the user, in any of variety of possible ways. As an example, the query response 160 can include providing the response to the end user. For instance, the system can provide the query response 160 through an API made available by the system 100, or through a graphical or text-based user interface. In the case that the user is remotely located from the system 100, the system 100 can provide the query response 160 to the user over a data communications network, e.g., internet.

FIG. 2 shows an example data generation and update system 200. The biological data generation and update system 200 is an example of a system implemented as computer programs on one or more computers in one or more locations in which the systems, components, and techniques described below are implemented. The system 200 can include a language processing neural network 220 and a graph neural network 250, which are each described in more detail next (and throughout this specification). In some examples, the language processing neural network 220 is the same language processing neural network as the language processing neural network 120 of FIG. 1. In other examples, the language processing neural network 220 is a separate language processing neural network.

In the case that there is no existing biological data graph 140, the system 200 can receive textual biological data 205, e.g., initial textual biological data characterizing biological entities and their respective relationships from a corpus of documents sourced to generate the biological data graph 140. As an example, the corpus of documents can be sourced from one or more available scientific publications or databases. As another example, the corpus of documents can come from one or more of proprietary data sources produced on a day-to-day basis by experimental and computational scientists.

The system 200 can then process the textual biological data 205 to generate the biological data graph 140. After the biological data graph 140 is generated, the system can receive and process additional textual biological data 205 to update the biological data graph 140. Both the generation and update functionality of the system 200 are described in further detail below.

The textual biological data 205 can include biological entity data that relates to any of numerous substances that are produced by living subjects or substances that impact living subjects. As an example, the textual biological data 205 can include data characterizing genes, proteins, compounds, deoxyribonucleic acid (DNA), ribonucleic acid (RNA), and single nucleotide polymorphisms (SNPs).

As another example, the textual biological data 205 can include omics data. Omics data can refer to, e.g., genomic data, transcriptomic data, proteomic data, metabolomic data, epigenomic data, or any combination thereof. Genomic data characterizes genetic information of a subject, e.g., the DNA sequence of the subject and gene expression in the subject.

Transcriptomic data characterizes RNA transcripts (e.g., mRNA, non-coding RNA) produced by a subject. Proteomic data characterizes the set of proteins produced by a subject. Metabolomic data characterizes metabolites produced by a subject. Epigenomic data characterizes changes in gene expression or function that are caused by modifications to the activity of a DNA segment without changing the sequence, e.g., through the addition of methyl groups associated with DNA.

As yet another example, the textual biological data 205 can include phenotype data.

Phenotypes of a biological subject are the observable physical, behavioral, or biochemical characteristics of the subject. Morphological phenotypes refer to the physical characteristics of an entity, such as shape and size. Physiological phenotypes relate to the function of the organs and systems of a subject, such as heart rate, blood pressure, or hormone levels. Biochemical phenotypes characterize the levels or activities of specific proteins, enzymes, or other molecules in a subject. Behavior phenotypes characterize the actions or reactions of a subject, such as the response of the subject to stimuli or social behavior of the subject.

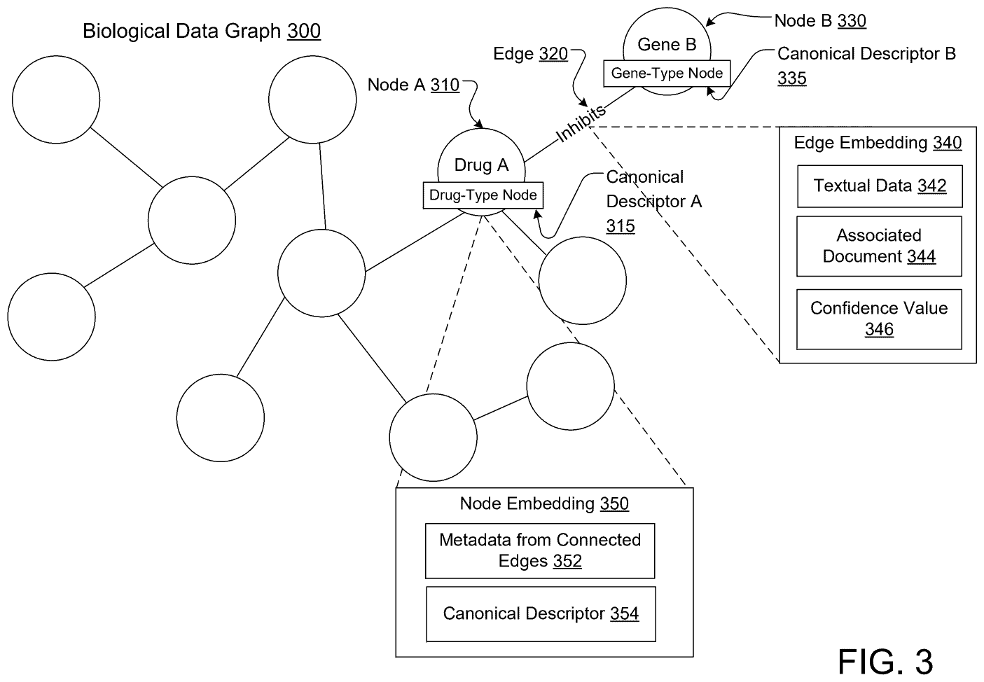

In another case, the textual biological data 205 can include augmentation data 250, in which case the language processing neural network 220 can associate the augmentation data 250 directly with a node or edge in the biological data graph 140. As an example, the augmentation data 250 can include a feature vector that can be associated with a node or edge, e.g., a canonical descriptor describing the type of node, e.g., a genotype or phenotype label, that can be associated with a node. An example of augmenting the biological data graph 140 using augmentation data 250 will be covered in more detail with respect to FIG. 3.

The system 200 can process the textual biological data 205 using the language processing neural network 220 to generate representative embeddings, e.g., embeddings 230. The language processing neural network 220 can have any appropriate neural network architecture that can be configured to process the textual biological data 205 and output an embedding of the textual input. In particular, this can involve processing the textual biological data 205 and deriving an intermediate representation of the processed textual data from the network 220, e.g., by taking the output of an intermediate layer of the network 220 to generate an ordered collection of numerical values in the dimensionality of the intermediate layer.

As an example, the system 200 can incorporate one or more of recurrent neural networks (RNN), autoencoders, or large language models (LLMs) as the language processing neural network 220. In particular, rather than being trained from scratch to embed the textual biological data 205, the language processing neural network 220 can be trained to perform a generic language modeling task, e.g., text generation on a corpus scraped from the internet, and further finetuned for textual biological data on a corpus of biological data.

More specifically, the system 200 can process the textual biological data 205, e.g., initial or additional textual biological data, using the language processing neural network 220 to generate current embeddings 230, e.g., initial embeddings and additional embeddings, respectively. In particular, the embeddings 230 can be created by processing textual biological data 205 characterizing biological entities and their respective relationships to generate node 232 and edge 234 embeddings. The system 200 can then further process the node 232 and edge 234 embeddings using the graph neural network (GNN) 250 as described below to generate and update the biological data graph 140.

In the case that there is no existing biological data graph 140, the initial node embeddings can be generated by processing textual data, or the initial node embeddings can be generated by setting the initial node embeddings 232 to a default embedding, e.g., an embedding where all values are zero, or randomly sampling values, e.g. from a probability distribution such as a Gaussian distribution, to generate the embedding.

The system can then use the GNN 250, a machine learning model that can efficiently process and manage graph-structured data, to process the embeddings 230 to generate the biological data graph 140. In particular, the GNN 250 can use message passing 255, a method for updating node 232 and edge 234 embeddings based on the aggregation of information from nearby node 232 and edge 234 embeddings into messages, to update the node 232 and edge 234 embeddings with respect to the relationships between them.

Message passing is parametrized by a set of graph network layer parameters of the GNN 250. In particular, message passing 255 leverages the transductive property of graphs, i.e., whenever new information is added to the graph 140, e.g., through the processing of textual biological data 205, rather than relearning how to message pass 255 over the entire biological data graph 140, the GNN 250 can apply transformations to the existing biological data graph 140 using the specified additional node embeddings 242, edge embeddings 244, or both to update the relevant current embeddings representing any new relationships formed by the additions to the graph 140.

More specifically, the GNN 250 can use transductive learning to only take the neighborhood around the new edges and nodes represented by the node 232 and edge 234 embeddings into account to update the current embeddings of the graph 140. The GNN 250 can update the biological data graph 140 directly instead of retraining on the entire graph 140 to perform the update, which can be extremely costly and prohibitively time and resource intensive.

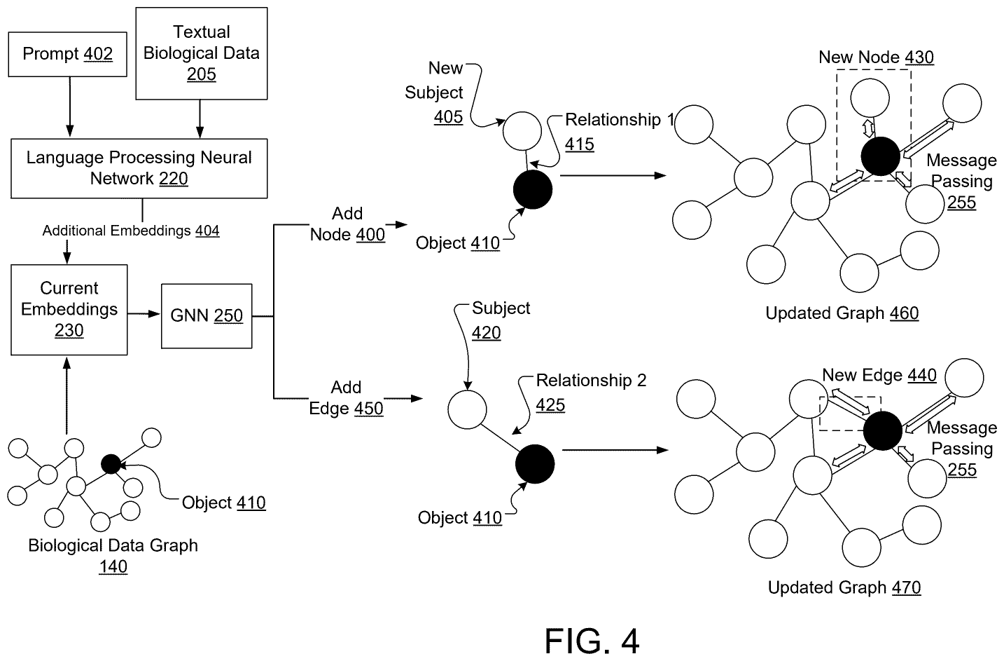

An example process for adding new nodes and edges to the biological data graph 140 using message passing 255 will be covered in more detail in FIG. 4.

More specifically, the GNN 130 can receive current, e.g., initial, edge embeddings 234 associated with the edges in the biological data graph and current, e.g., initial, node embeddings associated with the nodes in the biological data graph, and update the current edge embeddings and the current node embeddings by performing message passing 255 operations that are conditioned on the topology of the biological data graph 140. As an example, a message can contain information from the nodes in the one-hop away neighborhood of the node. In particular, the message used to update each node embedding can be a summation of the neighboring one-hop nodes multiplied by the relationship attribute of the edges multiplied by the trainable weights of the graph neural network. The current embedding for each node can then depend on the relational weights defined in the edge embeddings of the respective nodes' neighbors.

The system 200 can also use message passing 255 to update the biological data graph 140 with additional textual biological data 205. As an example, the system 200 can iteratively update the biological data graph 140 by processing a corpus of documents, e.g., a corpus obtained through a recent scientific literature search, using the language processing neural network 220 to define a plurality of biological relationship updates to the graph 140. For example, a biological relationship update can include adding a new biological entity node, a new relationship between existing biological entity nodes, or a new node and new relationship to the biological data graph 140 as described by the textual data 205 included in the corpus of documents.

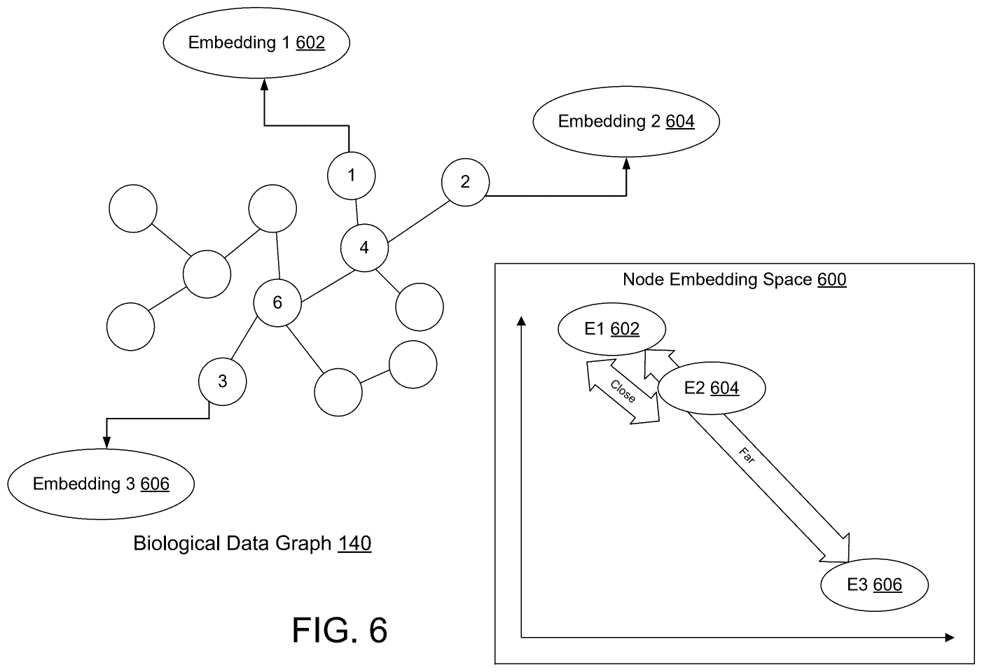

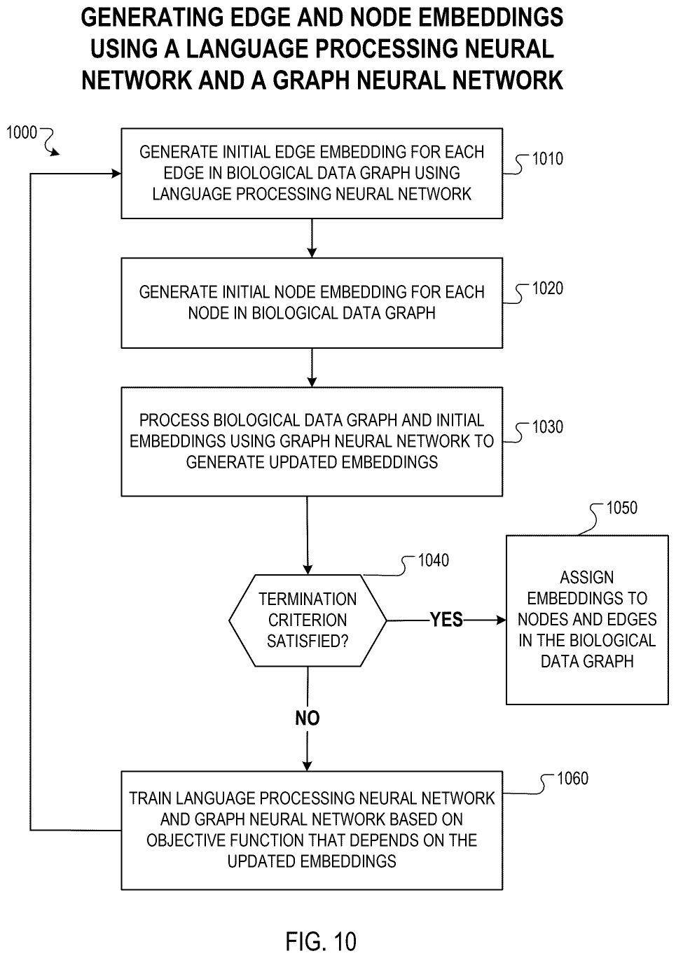

Since the GNN 250 takes the output of the language processing neural network 220 as a direct input, the GNN 250 is dependent on how the language processing neural network 220 embeds the textual biological data 205 into node and edge embeddings. Due to this dependency, the language processing neural network 220 and the GNN 250 can be jointly trained based on an objective function that depends on at least the current node embeddings 232. A particular example training protocol that uses a paired language processing neural network and GNN, e.g, the language processing neural network 220 and the GNN 250, to generate and update embeddings will be covered in more detail in FIG. 6 and FIG. 10.

FIG. 3 depicts an example biological data graph that includes nodes representing heterogeneous biological entities as well as edges that connect a respective pair of nodes and represent relationships between the biological entities corresponding to the respective pair of nodes. As an example, the biological data query system 100 of FIG. 1 can query the biological data graph 300. As another example, the biological data generation and update system 200 of FIG. 2 can generate and update the biological data graph 300.

In particular, the biological entities of the graph 300 can include genes, proteins, compounds, DNA, RNA, and SNPs (single nucleotide polymorphisms). In this case, nodes can be heterogeneous, e.g. the biological entities of the nodes in the graph do not need to be the same type of biological entity. The relationships represented by edges can include relationships that pertain to the types of biological entities that the edges connect. As an example, the type of biological entity of each node can be maintained as a canonical descriptor, e.g., as textual data associated with the biological entity node to label the type of heterogeneous node, such as a node representing a drug being designated as a drug-type node and a node representing a gene as a gene-type node. In an example in which an edge relates two gene-type nodes, the relationships can include co-expression or coregulation.

In the particular example depicted, both node A 310 and node B 330 have canonical descriptors: node A 310 is a drug-type node as represented by canonical descriptor A 315, and node B 330 is a gene-type node as represented by canonical descriptor B 325. The edge 330 between node A 310 and node B 330 represents a relationship between the drug of node A 310 that inhibits the gene of node B 330. As another example, other drug-type node to gene-type node edges can include edges representing increased gene expression or modification.

To mitigate the possibility that the language processing neural network, e.g., the language processing neural network 220 the system, e.g., the system 200, uses to generate the embeddings of the biological data graph 300, from creating nonsensical relationships, e.g., associations between types of biological entities that do not correspond with the types of plausible relationships between the biological entities, the options for relationships between the biological entities can be restricted to a set of plausible associations. As an example, when generating or updating the graph, 60 different relationships can be presented to the language processing neural network along with the initial or new textual biological data. In this case, prompt engineering can be used to generate probabilities for each of the relationships in the restricted set of relationships, as will be described in more detail with respect to FIG. 4.

Additionally, the system 200 can augment the biological data graph 300, e.g., by adding corresponding textual content metadata with the edges and nodes. As an example, the augmentation data can include the canonical descriptor or the source document, e.g., a document identifier or the portion of the document that identifies the relationship of the edge, for the edge between biological entity nodes. In another example, the augmentation data can include one or more experimental results from a data source that relate to the relationship of the edge.

The metadata associated with each edge or node can then be added to the graph 300 as a feature vector and embedded using a language processing neural network into a node 350 or edge 340 embedding. In particular, embedding a node or edge with metadata refers to processing the textual content that defines the biological entity or relationship and its associated metadata and embedding the associated textual content into a latent space of any appropriate dimensionality. For instance, the embedding latent space can have 10 dimensions, or 100 dimensions, or 1000 dimensions, or any other appropriate number of dimensions.

As an example, the language processing neural network 220 can process augmentation data, e.g., augmentation data 250, and incorporate the metadata into the node embedding 350. In particular, the node embedding 350 representation can include the metadata from connected edges 352 within the neighborhood of the specific entity node, e.g. within the vicinity of one or more edge connections. In some cases, the canonical descriptors 354 can also be included in the node metadata and can be embedded as well.

As another example, the language processing neural network 220 can process the edges and associated edge metadata to embed the edges in an edge embedding 340 representation that includes the textual data 342 and documents 344, e.g. the origin of the textual data describing the relationship, associated with the edge. This textual metadata can also be used to increase transparency and interpretability when querying the biological data graph 300, as is described in FIG. 5.

As another example, the edges can be associated with metadata from the language processing neural network 220. In particular, the probability of the edge relationship generated by the language processing neural network can be used to augment the edge to provide a confidence value 346, e.g., a confidence value associated with the relationships specified by prompt engineering, that describes the strength of the relationship represented by the edge. In this case, the confidence value 346 can also be encoded in the edge embedding 340.

FIG. 4 demonstrates how the system, e.g., the biological data graph generation and update system 200, can incorporate additional information into the biological data graph. As depicted in FIG. 2, the system 200 can process new textual biological data 205 to generate additional embeddings 404, e.g., a new node embedding, a new edge embedding, or both using the language processing neural network 220, and the system 200 can use the GNN 250 to process the current embeddings 230 including the additional embeddings 404 and the embeddings of the biological data graph 140 to add a new node, edge, or both to the graph 140.

In addition to the new textual biological data 210, the system 200 can use the language processing neural network 220 to process a prompt 402, as will be described in more detail below. In particular, the language processing neural network 220 can generate node and edge embeddings for the biological data graph in a scalable way using named-entity recognition in accordance with a prompt 402. Named-entity recognition is a form of natural language processing (NLP) that involves extracting and categorizing an entity from textual data. More specifically, in the parametrization of the biological data graph 140, named-entity recognition involves extracting information about a subject, object, and relationship that correspond with a subject node, e.g., a biological entity, object node, e.g., a biological entity, and relationship edge, e.g., an association between the subject and object biological entity nodes.

The system 200 can use a language processing neural network 220 to process new textual biological data 205 and a prompt 402 to automatically update the biological data graph 140, e.g. using prompt engineering to tailor the generated embedding output to the prompt 402. More specifically, prompt engineering can involve the system 200 providing the language processing neural network 220 with one or more prompts 402 defining precise questions to yield the intended embeddings 230 when processing new textual biological data 205. This ensures that the language processing neural network 220 can improve at extracting the subject, object, and relationship from relevant new textual biological data 205, such as scientific literature publications from a corpus of documents. As an example, a language processing neural network 120 can be used to parse through the documents to generate new node, new edge, or both embeddings with respect to the subject, object, relationship, or some combination of the aforementioned as defined in the prompt 402.

Potential entities can be more complex than just the name of a gene, phenotype, or a protein sequence. For example, an assay of interest or a phenotype of interest can be queried and understood by the language processing neural network 220. In some examples, the precision of the prompt engineering, e.g., the phrasing in the prompt 402, can enable the language processing neural network 220 to extract the correct subject-object entities even without finetuning on biological data using semantic matching. In other examples, finetuning on biological data can be completed such that the language processing neural network understands the corresponding subject-object entities directly.

As a further example, a user can present a corpus of biological documents, such as a number of publications, as new textual biological data 205 to the system 200. The system 200 can then use the language processing neural network 220 to process the documents with specific instructions, e.g., instructions in the prompt 402, as to which entities the language processing neural network 220 should search for in the textual content 205, such that the model 220 can proceed to sift through the biological documents in an automated fashion.

In a particular example, a user can specify a list of subject-object protein pairs, ask if the pairs exist in each paper using the prompt 402, and, if they do exist in the literature, specify to embed the relationship between them and extract supporting information, such as the paragraph that mentions the relationship, for use in the biological data graph as edge metadata. In particular, as a failsafe, the system 200 can store the content, e.g., the supporting paragraphs, and the source identifier from the document describing the relationship that the language processing neural network 220 used to create the edge embedding as edge metadata. This information can be returned to the user as part of the response, as will be described in further detail in FIG. 5.

In some cases, the system 200 can use the language processing neural network 220 to assess if the subject-object pair of the prompt 402 already exists in the biological data graph 140 and, if so, if the relationship between the subject-object pair follows any of the relationships that are currently defined in the graph. For example, the relationships can be limited for a set purpose, such as generating and updating a biological data graph for gene inhibition. In this case, the subject-object and relationship can be added to the graph in the form of one or more new node(s), or a new edge, or both.

The system can also use the language processing neural network 220 to leverage fuzzy matching, a technique that can identify semantically similar elements, to ensure a new biological entity does not already exist in the biological data graph 140 under a different name. In certain cases, an entity that is already present as a node in the biological data graph 140 under one name can be described or represented in another way. As an example, a gene can have seven different gene descriptions. In this case, if exact string matching was used to find an exact match, then more than one node that represent the same entity would be added to the graph. Having several nodes represent one biological entity can be problematic because the graph cannot properly represent the ontology if the relationships that belong to one node are incorrectly partitioned amongst a number of nodes.

In the case that the biological entities represented by nodes are associated with canonical descriptors, the system 200 can also use the language processing neural network 220 to separate the types of entities using the canonical descriptors. More specifically, each type of node can be associated with a different canonical descriptor, like a protein or gene node type that can be further specified using prompt engineering. As an example, the prompt 402 can specify the node type that the language processing neural network 220 should search for within the document and use the node type to more efficiently process the relationships between nodes of that node type already included in the biological data graph 140.

In a particular case, the system 200 can use the language processing neural network 220 to process new textual biological data that provides information for a new edge between two existing nodes of the biological data graph 300 and generate probabilities for relationships specified in the prompt 402, e.g., “is associated with”, “is caused by”, and “is experimentally observed”, to be encoded by the new edge. As an example, the language processing neural network 220 can generate relationship probabilities for “is associated with”, “is caused by”, and “is experimentally observed” of 0.2, 0.7, and 0.1, respectively. As described in FIG. 3, these probability values can be associated with the edges as metadata.

As another example, in the case that the language processing neural network is prompted to generate probabilities for a set of 10, 20, or 50 relationships, and the probabilities for a subset of three relationships from the full set of prompted relationships are 0.01, 0.15, and 0.2, the system can be further prompted to use a post-processing filter to drop the low probability, e.g., low confidence, relationships from the generated associations. More specifically, the prompt 402 can be tuned to specify that the language processing neural network 220 search for relevant relationships with respect to the type of node entities being assessed.

In a particular example in which the system 200 uses an LLM as the language processing neural network 220, the LLM can be prompted to perform very specific tasks with respect to the textual biological content. In particular, LLMs have demonstrated superior performance compared to other methods in extracting the named entities and the relationship between them from textual content. Users can give more explicit instructions within their prompt 402 precisely because the LLM can understand the semantic component of the prompt 402. As an example, an LLM can be prompted to “characterize the transcription of gene A as it relates to drug B” within new textual biological data 210, e.g., a publication in a corpus of biological documents, in order to add a new edge describing a relationship between existing gene A and drug B nodes.

The system 200 can use the language processing neural network 220 to process the new textual biological data 205 and the prompt 402 to generate additional embeddings 404. The system 200 can use the GNN 250 to process the current embeddings 230, including the additional embeddings 404 and the embeddings of the existing the biological data graph 140, to add a new node 400, a new edge 450, or both to the existing biological data graph 140. In particular, the system 200 can add a new node when it is determined that at least one of the extracted subject or object in the subject-object-relationship specified by the prompt 402 are not present in the graph 140, e.g., at least the subject 405 or object 410 node is not present in the graph.

In the particular example depicted, the subject node 405 is not in the original graph 450, so the system 200 adds the new node 430 with the edge corresponding to relationship 1 415 using the language processing neural network 220 to generate the embedding 240 and the GNN 250 to perform message passing to update the current embeddings 230 in accordance with the new node 430. Likewise, the system 200 can add a new edge when it is determined that both the subject and object of the extracted subject-object-relationship are present in the graph 140, e.g., the subject 420 and object 410. In this case, the system 200 can use the GNN 250 to add the new edge 440 corresponding with relationship 2 325 to the graph 140.

The GNN 250 can process the current embeddings 230, e.g., the additional embeddings 404 and the embeddings of the existing biological data graph 140, and iteratively process the node and edge embeddings adjacent to the updated embeddings associated with the new node 330 and new edge 340 to update each node and edge embedding in the updated graphs 360 and 370, respectively, with message passing 255.

FIG. 5 demonstrates how a biological data query system, e.g., the biological data query system 100 of FIG. 1, can use a question-answering machine learning model, e.g., a question-answering machine learning model as part of the graph querying subsystem 150, can process a query and the biological data graph to provide a response to an end user. As an example, an end user can be a scientist that aims to query the biological data graph 140 to assist in a target discovery, drug discovery, drug repurposing, off-target prediction, or biomarker discovery task.

In particular, the system 100 can use a question-answering machine learning model 500 to query the biological data graph 140 for information retrieval. In particular, the model 500 can be used to query the biological data graph 140 to answer questions about the ontology of the biological data graph, such as questions involving relationships between the biological entities of the graph, as specified by the query 110. In an example, a user can query the graph 140 directly, e.g., using an API that specifies interactions with the biological data graph 140, allowing for much more efficient searches over integrated biological information.

In the particular example depicted, the system 100 can use a language processing neural network 120 to process the query 110 to generate a query embedding 130. The graph querying subsystem 150 of FIG. 1 can then process the query embedding 130 and the biological data graph 140 to generate the query response 160, e.g., using a question-answering machine learning model 500, which will be described in more detail below.

In some examples, the language processing neural network 120 can embed the query into an edge embedding latent space 530, e.g., a latent vector space with the same dimensions as the edge embeddings. The graph querying subsystem 150 can then compare the embedded query 532 with different edge embeddings, e.g., the edge embeddings 534 and 536. In particular, the graph querying subsystem 150 can determine a respective similarity measure, e.g., a similarity measure based on the distance between the embedding of the query and the edge embeddings for each of one or more edges in the biological data graph 140, to select edges that are relevant to the query 110. In particular, the one or more edges selected can be associated with the edge embeddings having the highest similarity to the query embedding 130.

The biological data graph querying subsystem 150 can then process the textual data associated with the selected edges and the query 110 to generate a query response 160 using a question-answering machine learning model 500. For example, the textual data associated with the selected edges can provide context for answering the question as specified by the query 110. In particular, the system 100 can formulate the input to the language processing neural network 120, e.g., “Answer this question: [query 110] based on this context [textual data associated with selected edges in biological data graph 140]”.

The question-answering machine learning model 500 can have any appropriate neural network architecture configured to process textual data and perform next-character prediction. In particular, the language processing neural network 120 can include any appropriate types of neural network layers (e.g., fully connected layers, convolutional layers, attention layers, etc.) in any appropriate number (e.g., 5 layers, or 10 layers, or 100 layers) and connected in any appropriate configuration (e.g., as a directed graph of layers). In some examples, the question-answering machine learning model 500 can be an autoregressive neural network.

As an example, in the case of a target discovery problem, which involves searching for a gene or protein to target for finding a cure for a disease or reducing symptoms, a user can use the system 100 to query the biological data graph 140 regarding how the biological entities of interest are related. In particular, the system 100 can receive the query “What is the relation between gene A and drug B?” and can embed the query 110 as a query embedding 130 using the language processing neural network 120 in edge embedding latent space 530. Then, the graph querying subsystem 150 can determine a respective similarity measure between the query embedding 130 and the edge embeddings, to select the edges relevant to the query. The graph querying subsystem 150 can then process the textual data associated with those edges and the query 110 to generate the query response 160.

The question-answering machine learning model 500 can use semantic-based search to answer the question based on the querier's intent, even if the textual content of the biological data graph 140 does not contain the specific phrases used in the query 110. In particular, the question-answering machine learning model can use semantic vector matching to align the query 110 with the textual content of the selected edges.

Additionally, in some examples, if the textual content associated with the selected edges contains additional supporting metadata, such as the support document 514 that the relationship came from. As another example, the graph querying subsystem 150 can generate metadata through the process of selecting relevant edges, e.g., the system 100 can store an association score 512 that pertains to how well each selected edge embedding aligned with the query embedding 130. The metadata can also be returned to the user as part of the query response 160 for accountability and transparency purposes, e.g., to further elucidate why the relationship is encoded in the biological data graph 140.

As another example, the system 100 can precompute a vector-indexed database 520 of subject-object relationships from the biological data graph 140 every time a new node or edge is added and maintained for question-answering as a look-up table. In this case, the system 100 can match a query embedding 130 with an existing query in the database 520 and return the relevant response 160 to the user if there is a match.

In another example (not depicted), the graph querying subsystem 150 can generate the response to the query by determining a similarity measure between node embeddings. In particular, when the query 110 identifies a first biological entity and a second biological entity, the graph querying subsystem 150 can determine a similarity measure between the node embedding of the first biological entity and second biological entity.

In the case that the relationship of the query 110 is not encoded in the biological data graph 140 directly, the system 100 can use the language processing neural network 120 to compute link predictions between the biological entities of nodes to assess the probability of whether or not the relationship of the query 110 exists. In particular, the system 100 can use the language processing neural network 120 to form a path between the subject-object entity nodes specified by the query 110, if such a path exists, and can process the one or more embeddings related to the path to compute the probability of the relation asked about in the query 110. As a further example, a threshold can be defined in accordance with a path either not existing or being too convoluted to be associated with a relevant connection as it relates to the query 110.

As yet another example, if the graph querying subsystem 150 is unable to respond to the user's query 110, the system 100 can use the subsystem 150 to identify and return part of a document 514 that can be relevant to answering the query 110 as the query response 160, such that the user is pointed to a potentially useful resource for answering the question.

In some examples, the queries 110 the biological data query system 100 receives and their associated responses can be stored in a file, such as a JSON file where each key entry in the dictionary relates to a query 110 and each value relates to the corresponding response 160. In the case of a multi-subject-object relationship query, adjacent files can be written for each subject-object combination. Likewise, in the case of a multi-relationship query, a method can be used to separate each subject-object-relationship combination into separate JSON files.

FIG. 6 illustrates an example training process for the language processing neural network paired with the graph neural network to generate and update the biological data graph. In particular, FIG. 6 demonstrates a training process for both the language processing neural network 220 and the GNN 250 of FIG. 2 to learn how to generate embeddings and perform message passing to update the node and edge embeddings in accordance with the relationships represented in the textual biological data.

In particular, the language processing neural network 220 and the GNN 250 can be jointly trained by generating respective current edge and node embeddings using the language processing neural network 220 and adjusting the current values of the set of parameters of both models 220 and 250 based on an objective function that depends on the current node embeddings. More specifically, gradients of the objective function can be determined with respect to both the language processing neural network and the graph neural network, and the current values of the set of parameters can be adjusted using the gradients.

In particular, the language processing neural network 220 can learn how to embed the nodes of biological data graph 140 by sampling nodes from the biological data graph 140 randomly and leveraging the fact that the embeddings for neighboring nodes one-hop or a few hops away should be more similar than embeddings for non-neighboring nodes that are located in different regions of the graph, e.g., several edges away.

In this case, the objective function used to train the models 220, 250 can encourage an increase in similarity between node embeddings that are connected by an edge in the biological data graph 140 and a corresponding decrease in similarity between node embeddings that are not connected by an edge in the biological data graph 140. More specifically, the edges of the graph 140 as represented in the node embeddings can be used to quantify how similar nodes are amongst neighboring and non-neighboring nodes.

As an example, the similarity between nodes can be quantified as the distance between node embeddings in node embedding space 600. In the particular example depicted, embedding 1 for node 1 602 is closer to embedding 2 for node 2 604 in node embedding space 600, and embedding 3 for node 3 606 is farther away from embedding 1 in node embedding space 600. For example, node 1 and node 2 have respective relationships with a common node connection: node 4.

In certain examples, the similarity information can be encoded in the form of a link prediction probability, e.g., the probability of a link connecting the nodes. For example, node 1 is directly connected to node 4 and node 1 is connected to a node 3 through a path. In this method, the embedding for node 1 and node 4 are similar, and the embedding for node 1 and node 3, are not similar. The language processing neural network 220 can leverage this information to construct embeddings that represent the node path between 1 and 4 and 1, 4, 5, and 3. In particular, the path from 1 to 3 as represented in the node embedding should be longer than the path from 1 to 4. The embeddings can then be processed to provide a link prediction probability. As an example, the link prediction probability will be much higher for direct neighbors, like for the path between nodes 1 and 4, than for multi-hop paths such as the path between nodes 1 and 3.

The GNN 250 can be trained by comparing the embeddings between nodes after the GNN 250 performs message passing 255 to combine in the associated edge embedding information. In particular, a contrastive loss can be defined based on the updated node embedding similarity, which necessarily depends on the language processing neural network 220 embeddings, which are input directly to the GNN 250. For example, a pair of neighboring nodes can be represented by a positive value and a pair of non-neighboring nodes can be represented by a negative value. More specifically, the contrastive loss necessarily depends on the language processing neural network parameters, since the loss is a function of the edge embedding produced by the language processing neural network. The language processing neural network 220 and the GNN 250 can be trained using the contrastive loss such that the two models 220, 250 learn how to represent nodes and edges properly with respect to their relationships.

In some examples, the GNN is not trained concurrently with the language processing neural network. In this case, the language processing neural network 220 can either be trained using gradients of the objective function determined with respect to the current values of the set of parameters of the language processing neural network 220 or initialized to perform a language modeling task, e.g., in accordance with pretraining. Likewise, the GNN 250 can be initialized with certain parameters without the need for any auxiliary training. In particular, the GNN 250 can have been previously trained using link prediction on a different biological data graph to learn how to properly represent adjunctive subject-object relationships. In an example, the different biological data graph can include biological data. In another example, the different biological data graph can include data representing subject-object relationships of a non-biological nature.

A cadence for retraining on the full biological data graph can be defined in accordance with some criterion. For example, the cadence of retraining can be optimized for both the rate at which the corpus of biological documents is being updated, e.g., the rate at which new papers are coming out, and the cost of retraining. As another example, the biological data graph can be retrained every month or every year.

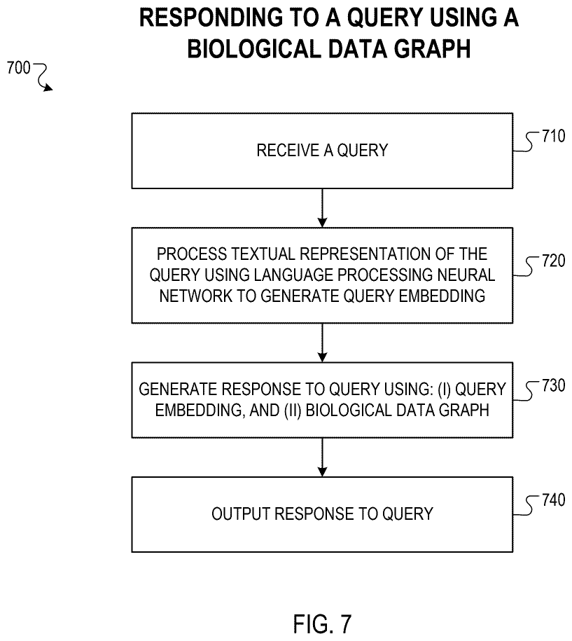

FIG. 7 is a flow diagram of an example process for querying a biological data graph with a language processing neural network. For convenience, the process 700 will be described as being performed by a system of one or more computers located in one or more locations. As an example, a biological data graph query system appropriately programmed in accordance with this specification, such as the biological data query system 100 of FIG. 1, can perform the process 700.

In particular, the system can receive a query (step 710). In particular, the query can identify a first biological entity, e.g., a gene, and a second biological entity, e.g., a drug, and inquire about the relationship between them. In an example, the system can receive a query from a user such as a scientist that can access the graph for querying, e.g., through an API. In another example, the user can be a machine-automated system that is paired with the biological data query system.

The system can then process a textual representation of the query using a language processing neural network to generate a query embedding (step 720). For example, the query embedding can be an intermediate output generated by the language processing neural network in response to processing the textual representation of the query. In some cases, the user can input a textual query directly into the API as the textual representation. In other cases, the user can verbally submit an audio query, in which case there can be an intermediate processing step to generate the textual representation of the query from the audio input.

The system can then generate a response to the query using the query embedding and a biological data graph (step 730). In some cases, the system can obtain an existing current biological data graph that includes a set of nodes, each node representing a respective biological entity, and a set of edges, each edge in the biological data graph connecting a respective pair of nodes and representing a relationship between the pair of biological entities. In other cases, the system can generate the biological data graph from textual biological information. In particular, the biological data graph can include at least 100,000 biological entity nodes.

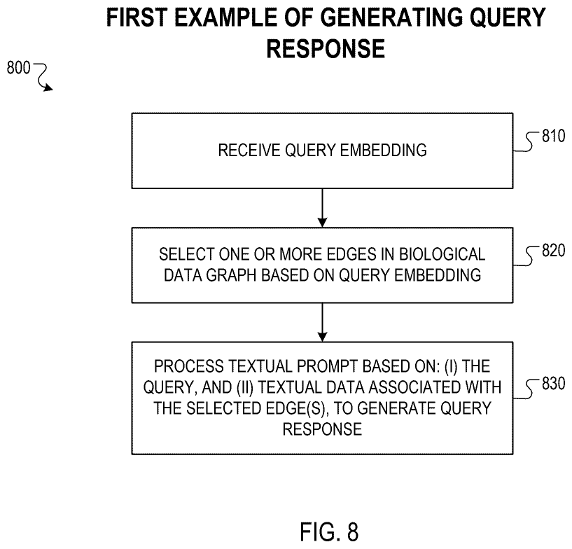

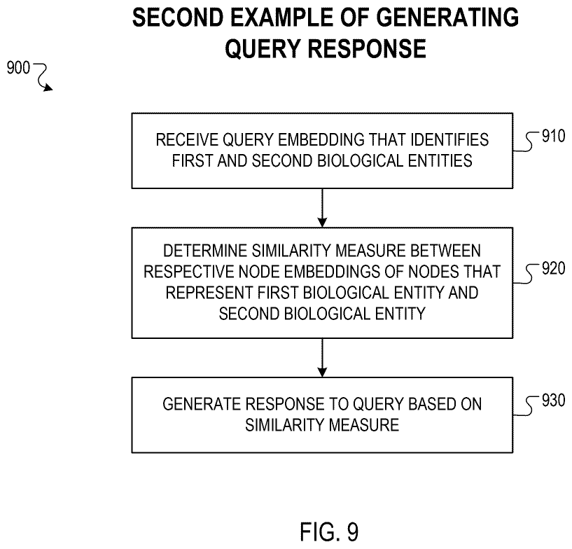

Each node and each edge of the biological data graph can be associated with respective node and edge embeddings. In some cases, the query response can be generated using one or more edges, more specifically, one or more edge embeddings representing a set of textual data describing the relationship represented by the edge in the biological data graph, as will be covered with respect to FIG. 8. In this case, the system can use a language processing neural network, such as an LLM, to generate the edge embeddings. In other cases, the query response can be generated using one or more nodes, more specifically, a measure of similarity between one or more node embeddings, in the biological data graph, as will be covered with respect to FIG. 9.

The system can then output the response to the query (step 740). In some examples, this can involve the system displaying the response to the query using an API. In particular, the response to the query can include an answer to a question posed by the query and any supporting information relevant to the query, such as associated metadata, e.g., documents from the biological textual data used to generate the biological data graph. In other examples, the response can be stored in memory or transmitted over a data communications network. In some cases, the system can generate the response to the query in less than one minute.

FIG. 8 is a flow diagram of an example process for querying a biological data graph using the set of edges of the biological data graph. For convenience, the process 800 will be described as being performed by a system of one or more computers located in one or more locations. As an example, a biological data query system appropriately programmed in accordance with this specification, such as the biological data query system 100 of FIG. 1, can perform the process 800.

The system can receive the query embedding (step 810), e.g., the query embedding generated by the language processing neural network as described in FIG. 7, and select one or more edges in the biological data graph based on the query embedding (step 820). In particular, the edges can be selected based on a comparison between the embedding of the query and the edge embeddings of the edges in the biological data graph.

For example, the system can define a respective similarity measure for each edge embedding, such as the distance between the query embedding and the edge embedding in the latent space defined by the dimension of the edge embeddings. The system can then select one or more edges in the biological data graph based on the similarity measure, e.g., by selecting one or more edges associated with edge embeddings having the highest similarity to the query embedding.

The system can process the textual prompt based on the query and the textual data associated with the selected edges to generate the query response based on the textual data describing the relationships represented by the selected edges in the biological data graph (step 830). In some cases, the system can use a question-answering machine learning model, e.g., an autoregressive neural network trained to perform next-character prediction, to generate the query response.

FIG. 9 is a flow diagram of an example process for querying a biological data graph using the set of nodes of the biological data graph. For convenience, the process 900 will be described as being performed by a system of one or more computers located in one or more locations. As an example, a biological data query system appropriately programmed in accordance with this specification, such as the biological data query system 100 of FIG. 1, can perform the process 900.

The system can receive the query embedding (step 910), e.g., the query embedding generated by the language processing neural network as described in FIG. 7. In particular, the query can identify a first and second biological entity. The system can then determine a similarity measure between the respective node embeddings of the nodes that represent the first biological and second biological entity of the query in the biological data graph (step 920). In particular, the nodes can be evaluated based on a similarity measure, such as the distance between the node embeddings in the latent space defined by the dimension of the node embeddings. The system can then generate the response to the query based on the similarity measure (step 930).

FIG. 10 is a flow diagram of an example process for training a paired language processing neural network and graph neural network to generate and update a biological data graph. For convenience, the process 1000 will be described as being performed by a system of one or more computers located in one or more locations. As an example, a biological data generation and update system appropriately programmed in accordance with this specification, such as the biological data generation and update system 200 of FIG. 2, can perform the process 1000.

The system can generate an initial edge embedding for each edge in a biological data graph using a language processing neural network (step 1010) and generate initial node embeddings for each node in the biological data graph using the language processing neural network (step 1020). In some cases, the language processing neural network has been trained to perform a language modeling task. In another case, the language processing neural network has both been trained to perform a language modeling task and fine-tuned to perform a task of extracting biological relationships from textual data.

As an example, the language processing neural network can process initial textual biological data to generate the initial edge and node embeddings. In particular, the initial edge and node embeddings can include an intermediate output, e.g., an embedding generated from an intermediate layer of the language processing neural network in response to processing the set of textual data describing the relationship represented by the edge. In some cases, the initial node embeddings can be generated by setting each respective initial node embedding to a default embedding, e.g., an embedding in which all values are zero. In other cases, the initial node embeddings can be generated by setting each respective initial node embedding to a random embedding, e.g., by sampling each value from a probability distribution such as a Gaussian distribution.

The system can then process the biological data graph and initial embeddings using a graph neural network (GNN) to generate updated embeddings (step 1030). In particular, the graph neural network can be configured to receive current edge embeddings associated with edges in the biological data graph and current node embeddings associated with the nodes in the biological data graph and update the current edge embeddings and the current node embeddings by performing message passing operations. More specifically, the GNN can include a sequence of graph neural network layers that are each configured to receive data identifying the current embeddings and the topology of the graph, perform message passing to update the current embeddings, and then output the current embeddings.

The system can then evaluate a termination criterion (step 1040), e.g., with respect to assigning the updated embeddings to the set of nodes and the set of edges of the biological data graph. In some cases, the termination criterion can be based on a number of iterations of training. In other cases, the termination criterion can be based on the value of the objective function when evaluated on the embeddings associated with the nodes and edges in the graph. For instance, the system can determine that a termination criterion is satisfied if the value of the objective function satisfies a threshold, e.g., a predefined threshold. When the termination criterion is satisfied, the system can assign the respective embeddings to the nodes and edges in the biological data graph (step 1050).

In the case that the termination criterion is not satisfied, the system can jointly train the language processing neural network and graph neural network based on an objective function that depends on the updated embeddings (step 1060). In particular, the objective function can encourage an increase in similarity between node embeddings of nodes, e.g., using an appropriate norm such as an L1 or L2 norm, that are connected by an edge in the biological data graph and encourage a decrease in similarity between node embeddings of nodes that are not connected by an edge in the biological data graph. In some examples, the objective function can be a triplet loss or maximum mean discrepancy loss.

In particular, the system can adjust the current values of the set of parameters of the language processing neural network and the set of parameters of the graph neural network using backpropagation. More specifically, the system can determine and backpropagate gradients of the objective function through the graph neural network and into the language processing neural network and adjust the current values using the gradients and the update rule of an appropriate gradient descent optimization technique, e.g., RMSProp or Adam.

After updating the current values of the set of parameters of the language processing neural network and the set of parameters of the graph neural network, the system can return to step 1010 to generate new initial embeddings. The system can then proceed through steps 1010-1040 to assess again if the termination criterion is satisfied.

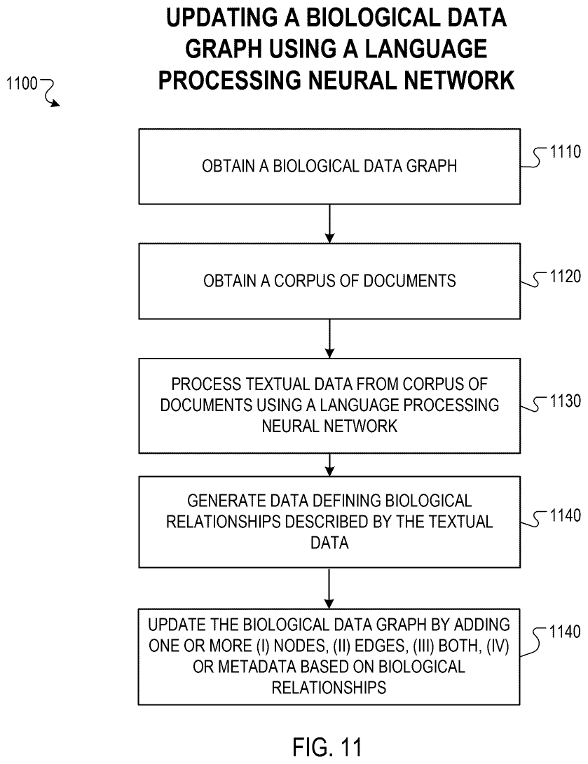

FIG. 11 is a flow diagram of an example process for updating a biological data graph using a language processing model. For convenience, the process 1100 will be described as being performed by a system of one or more computers located in one or more locations. As an example, a biological data generation and update system appropriately programmed in accordance with this specification, such as the biological data generation and update system 200 of FIG. 2, can perform the process 1100.

The system can obtain a biological data graph (step 1110) and a corpus of documents comprising textual data (step 1120). For example, the corpus of documents can include scientific publications. In some cases, the corpus can be assembled at some predefined cadence, such as every month, six months, or one year to ensure that the data in the biological data graph remains current.

The system can process the textual data from the corpus of documents using a language processing neural network (step 1130). In particular, the system can iteratively process the textual data in the corpus of document using the language processing neural network. In some cases, the system can also process a prompt defining a specific subject, object, or relationship to extract from one or more of the documents in the corpus. The system can then generate data defining a plurality of biological relationships described by the textual data (step 1140). In particular, the system can process the corpus of documents using the language processing neural network and generate one or more node, edge, or both embeddings that represent the biological relationships described by the textual data.

The system can update the biological data graph by adding one or more corresponding nodes, edges, both, or metadata to the biological data based on the generated biological relationships (step 1150). In some cases, updating the biological data graph can involve processing the edge and node embeddings of the existing graph with the additional embeddings to add one or more new nodes, new edges, or both to the biological data. In another case, the biological data graph can be augmented with metadata. For example, the edges of the biological data graph can be augmented with data identifying a document, from the corpus of documents used to source the biological data graph, that comprises textual data used to identify the biological relationship represented by the edge.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a query;
processing a textual representation of the query using a language processing neural network to generate an embedding of the query;
generating a response to the query using: (i) the embedding of the query, and (ii) graph data representing a biological data graph comprising a set of nodes and a set of edges, wherein:
each node in the biological data graph represents a respective biological entity;
each edge in the biological data graph connects a respective pair of nodes in the biological data graph and represents a relationship between a pair of biological entities corresponding to the respective pair of nodes; and
each edge in the biological data graph is associated with a respective edge embedding representing a set of textual data describing the relationship represented by the edge; and
the edge embeddings associated with the edges in the biological data graph are generated using the language processing neural network; and
outputting the response to the query.

2. The method of claim 1, wherein the edge embeddings associated with the edges in the biological data graph are generated using the language processing neural network by performing operations comprising:
generating: (i) a respective initial edge embedding for each edge in the biological data graph using the language processing neural network, and (ii) an initial node embedding for each node in the biological data graph; and
processing a network input that comprises: (i) the graph data representing the biological data graph, and (ii) the initial edge embeddings of the edges in the biological data graph and the initial node embeddings of the nodes in the biological data graph, using a graph neural network, to generate the edge embeddings associated with the edges in the biological data graph.

3. The method of claim 2, wherein for each edge in the biological data graph, the initial edge embedding associated with the edge comprises an intermediate output generated by the language processing neural network in response to processing the set of textual data describing the relationship represented by the edge.

4. The method of claim 2, wherein for one or more nodes in the biological data graph, generating the initial node embedding for the node comprises one or more of:
generating the initial node embedding for the node by processing textual data characterizing the biological entity represented by the node using the language processing neural network; or
setting the initial node embedding for the node to a default embedding; or
setting the initial node embedding for the node to a randomly sampled embedding.

5. The method of claim 2, wherein the graph neural network comprises a plurality of graph neural network layers that are each configured to:
receive current edge embeddings associated with the edges in the biological data graph and current node embeddings associated with the nodes in the biological data graph; and
update the current edge embeddings and the current node embeddings by performing message passing operations that are conditioned on a topology of the biological data graph and are parametrized by a set of graph network layer parameters.

6. The method of claim 2, wherein the language processing neural network and the graph neural network have been jointly trained by performing operations comprising, at each of a plurality of training iterations:
generating a respective current edge embedding for each edge in the biological data graph and a respective current node embedding for each node in the biological data graph using the language processing neural network and the graph neural network; and
adjusting the current values of the set of parameters of the language processing neural network and the set of parameters of the graph neural network based on an objective function that depends on at least the current node embeddings.

7. The method of claim 6, wherein the objective function encourages an increase in similarity between node embeddings of nodes that are connected by an edge in the biological data graph.

8. The method of claim 6, wherein the objective function encourages a decrease in similarity between node embeddings of nodes that are not connected by an edge in the biological data graph.

9. The method of claim 6, wherein adjusting the current values of the set of parameters of the language processing neural network and the set of parameters of the graph neural network based on an objective function that depends on the current edge embeddings comprises:
determining gradients of the objective function with respect to the set of parameters of the language processing neural network and the set of parameters of the graph neural network; and
adjusting the current values of the set of parameters of the language processing neural network and the set of parameters of the graph neural network using the gradients.

10. The method of claim 1, wherein the language processing neural network has been pretrained to perform a language modeling task.

11. The method of claim 1, wherein generating the response to the query using: (i) the embedding of the query, and (ii) the biological data graph, comprises:
selecting one or more edges in the biological data graph based on a comparison between the embedding of the query and the edge embeddings of the edges in the biological data graph; and
generating the response to the query based on the textual data describing the relationships represented by the selected edges in the biological data graph.

12. The method of claim 11, wherein selecting one or more edges in the biological data graph based on the comparison between the embedding of the query and the edge embeddings of the edges in the biological data graph comprises:
determining a respective similarity measure between: (i) the embedding of the query, and (ii) edge embeddings for each of one or more edges in the biological data graph; and
selecting one or more edges in the biological data graph based on the similarity measures.

13. The method of claim 12, wherein selecting one or more edges in the biological data graph based on the similarity measures comprises:
selecting one or more edges associated with edge embeddings having highest similarity to the embedding of the query from the edges in the biological data graph.

14. The method of claim 11, wherein generating the response to the query based on the textual data describing the relationships represented by the selected edges in the biological data graph comprises:
processing a textual prompt that includes: (i) the query, and (ii) the textual data describing the relationships represented by the selected edges in the biological data graph, using a question-answering machine learning model to generate the response to the query.

15. The method of claim 14, wherein the question-answering machine learning model comprises an autoregressive neural network trained to perform next-character prediction.

16. The method of claim 1, wherein the query identifies a first biological entity and a second biological entity; and
wherein generating the response to the query comprises:
determining a similarity measure between: (i) a node embedding of a node in the biological data graph that represents the first biological entity, and (ii) a node embedding of a node in the biological data graph that represents the second biological entity; and
generating the response to the query based at least in part on the determined similarity measure.

17. The method of claim 1, wherein the query concerns a relationship between a first biological entity and a second biological entity.

18. The method of claim 1, wherein outputting the response to the query comprises one or more of: providing the response to a user; storing the response in a memory; or transmitting the response over a data communications network.

19. A system comprising:
one or more computers; and
one or more storage devices communicatively coupled to the one or more computers, wherein the one or more storage devices store instructions that, when executed by the one or more computers, cause the one or more computers to perform operations comprising:
receiving a query;
processing a textual representation of the query using a language processing neural network to generate an embedding of the query;
generating a response to the query using: (i) the embedding of the query, and (ii) graph data representing a biological data graph comprising a set of nodes and a set of edges, wherein:
each node in the biological data graph represents a respective biological entity;
each edge in the biological data graph connects a respective pair of nodes in the biological data graph and represents a relationship between a pair of biological entities corresponding to the respective pair of nodes; and
each edge in the biological data graph is associated with a respective edge embedding representing a set of textual data describing the relationship represented by the edge; and
the edge embeddings associated with the edges in the biological data graph are generated using the language processing neural network; and
outputting the response to the query.

20. One or more non-transitory computer storage media storing instructions that when executed by one or more computers cause the one or more computers to perform operations comprising:
receiving a query;
processing a textual representation of the query using a language processing neural network to generate an embedding of the query;
generating a response to the query using: (i) the embedding of the query, and (ii) graph data representing a biological data graph comprising a set of nodes and a set of edges, wherein:
each node in the biological data graph represents a respective biological entity;
each edge in the biological data graph connects a respective pair of nodes in the biological data graph and represents a relationship between a pair of biological entities corresponding to the respective pair of nodes; and
each edge in the biological data graph is associated with a respective edge embedding representing a set of textual data describing the relationship represented by the edge; and
the edge embeddings associated with the edges in the biological data graph are generated using the language processing neural network; and
outputting the response to the query.
